(19) United States
(12) Patent Application Publication
(10) Pub. No.: US 2017/0109013 A1
(43) Pub. Date: Apr. 20, 2017

(54) METHOD FOR ORGANIZING GROUP ICON IN MESSENGER SERVICE, AND APPARATUS THEREFOR

(71) Applicant: SK PLANET CO., LTD., Seongnam-si (KR)

(72) Inventor: Jiwon HONG, Seoul (KR)

(21) Appl. No.: 15/394,073

(22) Filed: Dec. 29, 2016

Related U.S. Application Data
(63) Continuation of application No. PCT/KR2015/012817, filed on Nov. 27, 2015.

(30) Foreign Application Priority Data
Feb. 26, 2015 (KR) 10-2015-0027585

(51) Int. Cl. G06F 3/0481; G06F 17/27; G06F 3/0484; H04L 12/58; H04L 12/18

(52) U.S. Cl. CPC G06F 3/04817; H04L 51/04; H04L 12/1813; G06F 3/0484; G06F 17/2765

(57) ABSTRACT

The present invention relates to a method for organizing a group icon in a messenger service and, more specifically, to: a method for organizing a group icon in a messenger service, the method enabling clear confirmation of information on group members by merging the information on the members, which participate in a group chat, so as to display the information through the group icon during group chatting through a messenger service; and an apparatus therefor.

### CROSS REFERENCE

The present application is a continuation of International Patent Application No. PCT/KR2015/012817, filed Nov. 27, 2015, which is based upon and claims the benefit of priority to Korean Patent Application No. 10-2015-0027585, filed on Feb. 26, 2015. The disclosures of the above-listed applications are hereby incorporated by reference herein in their entirety.

### TECHNICAL FIELD

The present invention relates to a method for organizing a group icon in a messenger service and, more particularly, to a group icon organizing method and apparatus for merging information about members of a group chat in a messenger service and displaying the merged information through a group icon so as to simply provide such information about group chat members.

### BACKGROUND ART

Details disclosed in this section merely offer background information as to embodiments of the present invention and do not constitute prior art.

With the remarkable development of information communication technology, various kinds of terminals such as a mobile communication terminal and a personal computer are evolving to perform a great variety of functions.

For example, mobile communication terminals not only provide a traditional voice communication function, but also offer various functions such as a data communication function, a digital camera function, a multimedia playback function, a game function, a broadcast receiving function, and the like.

Technological developments for enhancing such functions executable in these terminals have been continuously made through improvements in software as well as hardware.

Meanwhile, a messenger program capable of transmitting and receiving chat messages to and from a lot of users through access to a communication network using such a terminal has been widely used in recent years.

This messenger program allows users to use a group chat on a single chat window as well as a one-to-one chat. For a group chat, a user can create a group chat window by selecting several chatting partners and requesting a chat in the messenger program. Also, a user can change a previously created one-to-one chat window to a group chat window by adding a chatting partner.

This group chat window provides a function to check information about members participating in a group chat. However, this function requires cumbersome user inputs for identifying member information.

Therefore, it is required to develop a method for simply providing member information through a group chat window and expressing such information in various manners.

### DISCLOSURE

### Technical Problem

The present invention is proposed to solve the above-mentioned problem and, especially, has an object of providing a group icon organizing method and apparatus in a messenger service such that information about members participating in a group chat can be easily found through a group icon during the group chat in the messenger service.

Additionally, the present invention has an object of providing a group icon organizing method and apparatus in a messenger service such that a group icon created using information about members participating in a group chat can be dynamically created or changed in various manners.

Additionally, the present invention has an object of providing a group icon organizing method and apparatus in a messenger service such that a group icon can be created on the basis of currently transmitted/received messages as well as information about members participating in a group chat.

However, the object of the present invention is not limited to the above-mentioned objects, and any other object not mentioned may be clearly understood from the following description.

### Technical Solution

In order to accomplish objects as discussed above, an apparatus for organizing a group icon in a messenger service according to embodiments of the present invention may include a message display module configured to display information associated with an execution of a messenger program; a messenger processing module configured to display, through the message display module, a chat window list screen of the messenger program on which one or more pre-created chat window lists are displayed, and to, if there is an item for a group chat window connected with at least two partner terminals in the chat window list, control the group icon, requested and delivered from a group icon creation module, to be displayed on an item for the group chat window; and the group icon creation module configured to create, based on a predefined rule, the group icon by merging user icons for partner terminals participating in a group chat.

In this apparatus, the messenger processing module may be further configured to display a group chat window screen selected from the chat window list screen, and to, if the group icon changed according to messages transmitted or received through the group chat window is delivered through the group icon creation module, control the changed group icon to be displayed in a certain area of the group chat window screen.

In this apparatus, the group icon creation module may be further configured to create the group icon by arranging and merging user icons of the at least two partner terminals in the order of participating in the group chat.

In this apparatus, the group icon creation module may be further configured to, if there is a predefined keyword in messages transmitted or received to or from the at least two partner terminals through the group chat window, create the group icon by using an icon assigned to the predefined keyword.

In this apparatus, the group icon creation module may be further configured to, when creating the group icon by merging the user icons, determine reference colors of the user icons and create the group icon according to the determined reference colors.

In this apparatus, the group icon creation module may be further configured to, if there are user icons of the partner terminals more than the maximum number of user icons being mergeable into the group icon, extract specific user icons and merge the extracted user icons into the group icon.

In this apparatus, the group icon creation module may be further configured to, when extracting the specific user icons, consider the number of messages transmitted or received through the group chat window or consider the order of entry into the group chat window.

In order to accomplish objects as discussed above, a method for organizing a group icon in a messenger service according to embodiments of the present invention may include steps of: when a messenger program is executed, determining whether there is a group chat window connected with at least two partner terminals in one or more pre-created chat windows; if there is the group chat window, creating a group icon, based on a predefined rule, by merging user icons for partner terminals participating in a corresponding group chat; and controlling an item for the group chat window containing the created group icon to be displayed through one or more pre-created chat window lists.

This method may further include steps of: when one group chat window is selected from the chat window list screen, displaying the selected group chat window screen; changing the group icon according to messages transmitted or received through the group chat window; and controlling the changed group icon to be displayed in a certain area of the group chat window screen.

In addition, the present invention may provide a computer-readable storage medium recording thereon a program for executing the above method for organizing a group icon in a messenger service according to embodiments of the present invention.

In order to accomplish objects as discussed above, a computer-readable storage medium recording thereon a program for executing a for organizing a group icon in a messenger service, the method comprising steps of: when one group chat window is selected from the chat window list screen, displaying the selected group chat window screen; changing the group icon according to messages transmitted or received through the group chat window; and controlling the changed group icon to be displayed in a certain area of the group chat window screen.

### Advantageous Effects

According to the method and apparatus for organizing a group icon in a messenger service of this invention, it is possible to easily find information about members participating in a group chat through the group icon during the group chat in the messenger service.

Also, according to this invention, it is possible to provide an improved messenger service by creating or changing a group icon in various manners such as referring to currently transmitting/receiving messages as well as information about members participating in a group chat.

Other various advantages and effects will be disclosed explicitly or implicitly in embodiments of this invention to be described below in detail.

### DESCRIPTION OF DRAWINGS

FIG. 1 is a schematic diagram of a messenger system that applies a group icon organizing method to a messenger service according to embodiments of the present invention.

FIG. 2 is a block diagram illustrating main elements of a terminal shown in FIG. 1 according to embodiments of the present invention.

FIG. 3 is a block diagram illustrating main elements of a messenger service apparatus shown in FIG. 1 according to embodiments of the present invention.

FIG. 4 is a flow diagram illustrating a method for organizing a group icon in a messenger service according to one embodiment of the present invention.

FIG. 5 is a flow diagram illustrating a method for organizing a group icon in a messenger service according to another embodiment of the present invention.

FIG. 6 is a flow diagram illustrating in detail a method for organizing a group icon in a messenger service according to embodiments of the present invention.

FIGS. 7 and 8 are exemplary screenshots illustrating a group icon organizing method according to embodiments of the present invention.

FIG. 9 is a block diagram illustrating an operating environment of an apparatus for organizing a group icon according to embodiments of the present invention.

### MODE FOR INVENTION

Now, embodiments of the present invention will be described with reference to the accompanying drawings.

In the following description and the accompanying drawings, however, well known techniques may not be described or illustrated in detail to avoid obscuring the subject matter of the present invention. Through the drawings, the same or similar reference numerals denote corresponding features consistently.

The terms and words used in the following description, drawings and claims are not limited to the bibliographical meanings and are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

The expression “first”, “second”, and the like used in various embodiments of this disclosure may modify various elements of such embodiments but does not limit the corresponding elements. The above expressions do not limit the sequence and/or importance of the elements but may be used for distinguishing one element from other elements. For example, a first device and a second device indicate different devices although both of them are devices.

When it is stated that a certain element is “coupled to” or “connected to” another element, the element may be directly coupled or connected to another element, or a new element may exist between both elements. In contrast, when it is stated that a certain element is “directly coupled to” or “directly connected to” another element, a new element does not exist between both elements.

The terms used in describing various embodiments of this disclosure are only examples for describing a specific embodiment but do not limit such embodiments. Singular forms are intended to include plural forms unless the context clearly indicates otherwise. Unless defined differently, all terms used herein, which include technical terminologies or scientific terminologies, have the same meaning as that understood by a person skilled in the art to which the present disclosure belongs. The terms “include”, “comprise” and “have” as well as derivatives thereof, mean inclusion without limitation.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as one or more data links (of possibly different speeds) that enable the transport of electronic data between computer systems and/or modules (e.g., hardware and/or software modules). When information is transferred or provided over a network or another communications connection (either hardwired, wireless, or a combination of hardwired or wireless) to a computer system, the connection is properly viewed as a computer-readable medium. Computer-executable instructions include, for example, instructions and data which cause a general-purpose computer system or special-purpose computer system to perform a certain function or group of functions. The computer executable instructions may be, for example, binaries, intermediate format instructions such as assembly language, or even source code.

Additionally, the present invention may be practiced in network computing environments that have various kinds of computer system configuration including personal computers, laptop computers, hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In this disclosure, the term “icon” is a concept including various contents that may be displayed to a user through a messenger program, and refers to information that may be utilized to identify a user using the messenger program or a group containing the user. This icon may be represented as text, an image, a thumbnail image of video, an illustration, a picture, a symbol, or a combination of different types of contents such as an image and text.

Now, a method and apparatus for organizing a group icon in a messenger service according to embodiments of the present invention will be described with reference to the accompanying drawings.

At the outset, a messenger system that applies a group icon organizing method to a messenger service according to embodiments of the present invention will be described in detail.

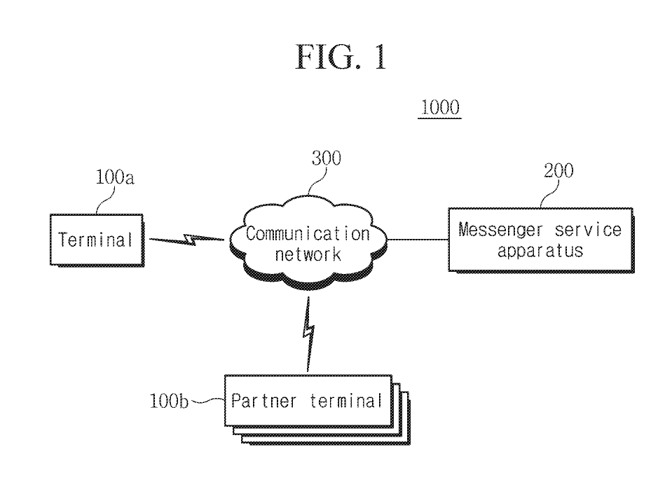

FIG. 1 is a schematic diagram of a messenger system that applies a group icon organizing method to a messenger service according to embodiments of the present invention.

Referring to FIG. 1, the messenger system 100 may include a plurality of terminals 100, a messenger service apparatus 200, and a communication network 300 that supports transmission and reception of information between the terminals 100 and the messenger service apparatus 200.

Specifically, the terminal 100 refers to a user's apparatus capable of transmitting or receiving various kinds of data via the communication network 300 according to user's manipulations. The terminal 100 may perform voice or data communication through the communication network 300 and transmit or receive various kinds of information to or from the messenger service apparatus 200. For this, the terminal 100 may have a memory for storing a browser, program and protocol for transmission and/or reception of information, a microprocessor for executing and controlling programs, and other elements required inherently or optionally.

Hereinafter, for convenience of explanation, such terminals will be divided into a user terminal 100a and a partner terminal 100b, based on the owner of a terminal. Normally a plurality of partner terminals 100b may exist. If no distinction is required, such terminals will be referred to as the terminal 100. The user terminal 100a may also operate as a partner terminal.

The terminal 100 may transmit or receive information to or from the messenger service apparatus 200 via the communication network 300 and also use a messenger service through a messenger program offered by the messenger service apparatus 200. Here, the messenger program that can be offered by the messenger service apparatus 200 may be a program capable of providing an instant messaging service. Such a messenger program may be downloaded from the messenger service apparatus 200 and then installed in the terminal 100. Even though the messenger program is not installed, the terminal 100 may use the messenger program in a cloud service manner by accessing the messenger service apparatus 200.

The terminal 100 may execute the messenger program and display a messenger program execution screen (e.g., an initial screen, a chat window screen, etc.). Here, the messenger program may be executed in response to a user's request or when a specific event occurs. This specific event may be, for example, the reception of a message from a partner or the reception of specific information from the messenger service apparatus 200. Additionally, the user terminal 100a may perform a group chat with a plurality of the partner terminals 100b through the messenger program offered by the messenger service apparatus 200 and also support processes of creating a group icon by using information about the partner terminals in the group chat and then displaying the group icon through various areas of the messenger program.

Details of the group icon organizing method performed at the terminal 100 will be discussed below. In embodiments of this invention, the terminal 100 may be implemented in various forms. For example, the terminal 100 disclosed herein may be a mobile device such as a smart phone, a tablet personal computer (tablet PC), a personal digital assistant (PDA), a portable multimedia player (PMP), an MP3 player, and the like, or a stationary device such as a smart TV, a desktop computer, and the like.

According to a recent trend of convergence in digital devices, a great variety of mobile devices or their equivalences may be used as the terminal 100. Further, any device that can transmit or receive information to or from the messenger service apparatus 200 through the communication network 300 may be used as the terminal 100 in embodiments of this invention.

The messenger service apparatus 200 performs a function for supporting transmission and reception of messages or contents between the terminals 100 through the messenger program. For example, the messenger service apparatus 200 may control the whole process of receive a message from the user terminal 100a and then transmit the received message to one or more partner terminals 100b connected through a chat window of the messenger program, and vice versa.

Additionally, the messenger service apparatus 200 may store messages or contents currently transmitted or received through a chat window and then offer them in response to a user's request. Namely, if any user input corresponding to a predefined condition, e.g., a swipe action in one direction, is detected on a chat window screen of the terminal 100a in a state where the terminal 100a and the partner terminal(s) 100b are connected through the chat window of the messenger program, the messenger service apparatus 200 may store messages or contents currently transmitted or received through the chat window screen and then offer the stored messages or content at any time in response to a user's request.

Preferably, such messages or contents transmitted or received through the messenger program of the terminal 100 may be stored in and managed by the messenger service apparatus 200 rather than stored in the terminal 100.

Additionally, a user of the terminal 100 may access the messenger service apparatus 200 and then check messages or contents exchanged with a partner. Here, access may include a login procedure as to the messenger service apparatus 200. Alternatively, the terminal 100 may be automatically connected with the messenger service apparatus 200 without a login procedure. In addition, a user of the terminal 100 may receive in advance related information from the messenger service apparatus 200 and promptly find this through an execution screen of the messenger program. If any user input for selecting a specific object or command displayed on the execution screen of the messenger program is detected, direct access to the messenger service apparatus 200 may be made.

Also, messages or contents transmitted or received through the messenger program may be simultaneously stored in the terminal 100 and the messenger service apparatus 200. Alternatively, depending on user's selection, specific messages or contents only may be stored in the messenger service apparatus 200.

Besides, the messenger service apparatus 200 may identify subscribed users with user identifiers so as to provide a messenger program service to a plurality of the terminals, manage a status, a receiving mode, a message recipient list, and subscriber environment information with regard to each subscribed user, and manage an IM chat session, i.e., a chat channel, for delivery of IM chat messages between on-line users. Also, the messenger service apparatus 200 may perform an SIP (Session Initiation Protocol) call processing and MSRP (Message Session Relay Protocol) relay function or the like, and through this, can provide a chat service between a plurality of terminals, e.g., the user terminal 100a and the partner terminal 100b.

Particularly, the messenger service apparatus 200 according to embodiments of this invention may control a process for a group chat between the user terminal 100a and a plurality of the partner terminals 100b, based on the messenger program. For example, the messenger service apparatus 200 may support a process of establishing a chat session for a group chat between the user terminal 100a and the partner terminals 100b, a process of transmitting or receiving messages, etc. and, particularly, control a process of creating a group icon for indicating members who participate in the group chat.

In order to support the above operations, the messenger service apparatus 200 may be implemented as a set of various devices, for example, a database server for storing and managing related information, a file server for processing a file, a push server for automatically pushing related information to the terminal 100, and the like.

In addition to the above, various servers may be included depending on system design schemes. Also, functions corresponding to the above servers may be realized as a single module in the messenger service apparatus 200.

Main elements and detailed operation methods of the terminal 100 and the messenger service apparatus 200 will be described below. A processor embedded in the terminal 100 and the messenger service apparatus 200 according embodiments of this invention may process a program command for executing the method of this invention. This processor may be a single-threaded processor or a multi-threaded processor. Also, this processor may process commands stored in a memory or any other storage.

Meanwhile, the aforesaid state of being connected through the chat window refers to a state where a transfer route, i.e., a session, for transmitting or receiving messages between the terminals 100.

For example, this may be a concept including an activity of the first terminal 100a for creating a chat window by selecting one or more second terminals 100b for a chat, an activity of the first terminal 100a for transmitting a user's input message to one or more second terminals 100b, and the like.

The terminals 100 and the messenger service apparatus 200 transmit and receive various kinds of information to and from each other through the communication network 300. The communication network 300 may use wireless communication technique such as, but not limited to, WLAN (Wireless Local Access Network), Wi-Fi, Wibro, Wimax, HSDPA (High Speed Downlink Packet Access), or the like. Alternatively or additionally, depending on system types, the communication network 400 may use wired communication technique such as Ethernet, xDSL (ADSL, VDSL), HFC (Hybrid Fiber Coaxial cable), FTTC (Fiber To The Curb), FTTH (Fiber To The Home), or the like.

Additionally, the communication network 400 includes a plurality of access networks (not shown) and a core network (not shown), and may further include an external network, e.g., Internet (not shown). Here, the access network is to perform wired/wireless communication with the terminal 100 and may be formed of a plurality of base stations, also referred to as BTS (Base Transceiver Station), NodeB, or eNB (eNodeB or evolved Node B), and controllers such as BSC (Base Station Controller) and RNC (Radio Network Controller). Additionally, instead of such a base station that includes a digital signal processor and a radio signal processor, a plurality of radio units (not shown) corresponding to the radio signal processor may be disposed respectively at a plurality of regions and connected to a centralized digital unit (not shown) corresponding to the digital signal processor.

The core network which forms a mobile network together with the access network performs a function to connect the access network and the external network such as Internet.

The core network is a network system that performs main functions for a mobile communication service such as mobility control and switching between the access networks. Namely, the core network performs circuit switching or packet switching and further manages and controls a packet flow in the mobile network. In addition, the core network may manage mobility between frequencies, control traffic therein and in the access network, and control interworking with other network such as Internet. The core network may be formed of SGW (Serving GateWay), PGW (PDN GateWay), MSC (Mobile Switching Center), HLR (Home Location Register), MME (Mobile Mobility Entity), HSS (Home Subscriber Server), and/or the like.

The Internet is a world common network through which information is exchanged according to TCP/IP protocol. The Internet is connected to the messenger service apparatus 200 and may deliver information, offered from the messenger service apparatus 200, to the terminal 100 through the core network and the access network. Similarly, the Internet may deliver information, offered from the terminal 100, to the messenger service apparatus 200 through the core network and the access network.

In addition to the above communication technique, any other communication technique which is well known or will be developed may be used.

Hereinafter, main elements and operations of the terminal 100 according to embodiments of this invention will be described.

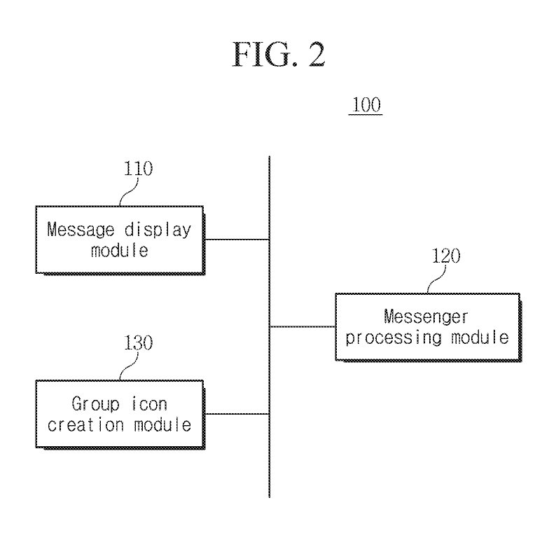

FIG. 2 is a block diagram illustrating main elements of a terminal shown in FIG. 1 according to embodiments of the present invention.

Referring to FIGS. 1 and 2, the terminal 100 according to embodiments of this invention may include, in view of functionality, a message display module 110, a messenger processing module 120, and a group icon creation module 130. In this disclosure, the term “module” may refer to an element which is formed of software, hardware, or combination thereof, and performs certain tasks. A module may be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Now, each module of the terminal 100 will be described in detail. The message display module 110 may perform a function of displaying information associated with the execution of a messenger program. The message display module 110 may transmit various kinds of information associated with the execution of the messenger program to a display device capable of communication, thereby allowing a user to recognize information through the display device. When the messenger program is executed, the message display module 110 may display a chat window list screen that contains at least one pre-created chat window list. Here, the chat window list screen may contain an item regarding a group chat window connected with two or more partner terminals, and this item regarding the group chat window may include a group icon.

The messenger processing module 120 may control the whole process of executing the messenger program according to embodiments of this invention and also control the whole operation of processing various kinds of information offered by the messenger program. Particularly, when the messenger program is executed, the messenger processing module 120 may control a process of displaying the chat window list screen containing at least one pre-created chat window list through the message display module 110 so as to be recognizable to a user. Also, if there is an item for the group chat window connected with two or more terminals among items for the chat windows displayed in the chat window list screen, the messenger processing module 120 may request the group icon creation module 130 to create a group icon, receive the created group icon from the group icon creation module 130, and control the display of the group icon on the item for the group chat window.

Additionally, in a group chat window screen while a group chat is performed, the messenger processing module 120 may request and receive the group icon from the group icon creation module 130 and control the display of the group icon on a certain area of the group chat window screen.

The group icon creation module 130 performs a function of creating the group icon according to embodiments of this invention. At this time, the group icon creation module 130 may create the group icon by merging user icons regarding partner terminals participating in the group chat, based on a predefined rule.

Specifically, each user of the terminals that use the messenger program may set a user icon for distinguishing the user from the other users. Here, information that can be assigned to the user icon may include emoticons, text, images, etc. offered by the messenger service apparatus 200, or any other information that can be set by a user. For example, a user of the terminal 100 may assign a specific photo stored in the terminal 100 to the user icon.

The group icon creation module 130 may create the group icon by merging such user icons. In this case, if there is a group chat window, the group icon creation module 130 may create the group icon by merging user icons of two or more partner terminals 100b, except the user icon of the user terminal 100a (if necessary, may be included depending on system implementations), based on a predefined rule. At this time, the group icon creation module 130 may create the group icon by arranging and merging the user icons of the partner terminals 100b in the order of participating in the group chat. For example, let's suppose that when the user performs a one-to-one chat with a partner A through a one-to-one chat window, another partner B enters the chat window and thereby the user performs a group chat with partners A and B. In this example, the group icon creation module 130 may create the group icon by merging the user icons of the partner terminals 100b in the order of partners A and B who participate in the group chat. However, even though having the previous order of participating in the group chat, the partner terminal 100b that does not set the user icon may be excluded from the group icon.

Additionally, if there is a predefined keyword in messages transmitted or received to or from the partner terminals 100b through a group chat window, the group icon creation module 130 may create the group icon in the group chat window by using the group icon assigned to the predefined keyword. For example, if the predefined keyword “love” frequently appears in messages transmitted or received through the group chat window, a heart icon assigned to the keyword “love” may be determined as the group icon. In another example, if the predefined keyword “idol” frequently appears in messages transmitted or received through the group chat window, an entertainer's photo assigned to the keyword “idol” may be determined as the group icon. Further, text such as “talking about ooo” may be displayed near the group icon so as to indicate a current chat topic in the group chat window.

Also, when creating the group icon by merging user icons for two or more partner terminals 100b, the group icon creation module 130 may determine reference colors of two or more user icons and create the group icon according to the determined reference colors. For example, let's suppose that users of the partner terminals 100b participating in the group chat are three users A, B and C. If color information about icons of the users A and B indicates that the leading color is red, and if color information about an icon of the user C indicates that the leading color is blue, the leading color of the user C's icon may be changed to red when the group icon is created by merging icons of the users A, B and C.

Also, if there are user icons of the partner terminals 100b more than the maximum number of mergeable user icons when user icons for two or more partner terminals 100b are merged, the group icon creation module 130 may extract specific user icons and then merge the extracted user icons into the group icon. For example, in case of a group chat composed of twenty members, it may be difficult to create a group icon by merging user icons of nineteen partners except for the user. Therefore, if the partner terminals 100b exist more than the maximum number (e.g., four or more) of mergeable user icons, the group icon creation module 130 extracts specific user icons. When extracting the specific user icons, the group icon creation module 130 may consider the number of messages transmitted or received through the group chat window or consider the order of entry into the group chat window. In other words, the user icons may be extracted from members who are leading the group chat, or extracted in the order of participating in the group chat such as the latest participant or the earliest participant.

When the group icon creation module 130 creates the group icon from various points of view as discussed above and then delivers this to the messenger processing module 120, the messenger processing module 120 displays the group icon through the chat window list screen or the group chat window screen. Therefore, the user can easily find information about members participating in the group chat or an atmosphere of the group chat through the group icon.

Also, the group icon may be changed in real time during the group chat.

Hereinbefore, main elements of the terminal 100 have been described in view of functionality through FIG. 2. However, the elements shown in FIG. 2 are not all essential element. In other words, although only the message display module 110, the messenger processing module 120, and the group icon creation module 130 are illustrated in drawings, various other functional modules may be further included for providing the messenger service.

For example, a communication module (not shown) for supporting a function of supporting transmission and reception of various kinds of information with the messenger service apparatus 200 through the communication network 300, an input module (not shown) for supporting various user inputs generated through the messenger program, and a storage module (not shown) for storing related information for executing the messenger program and supporting access to the stored information, and the like may be further included.

Hereinafter, main elements and operations of the messenger service apparatus 200 according to embodiments of this invention will be described.

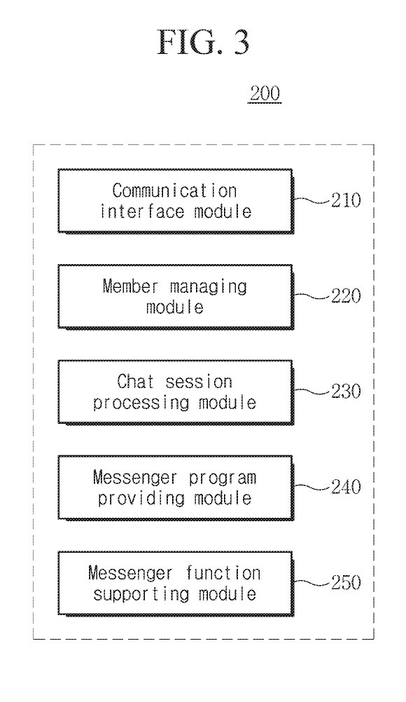

FIG. 3 is a block diagram illustrating main elements of a messenger service apparatus shown in FIG. 1 according to embodiments of the present invention.

Referring to FIGS. 1 and 3, the messenger service apparatus 200 according to embodiments of this invention may include a communication interface module 210, a member managing module 220, a chat session processing module 230, a messenger program providing module 240, and a messenger function supporting module 250.

Each element will be described in detail. The communication interface module 210 performs a function of supporting transmission and reception of information through a communication device with a plurality of terminals 100.

The member managing module 220 manages information about users who use the messenger service according to embodiments of this invention, and also performs a function of storing and managing various kinds of information created in connection with the use of the messenger service by each user. The user may be registered as a member of the messenger service through only a process of installing the messenger program in the user terminal 100a without any membership procedure. At this time, the member managing module 220 may support the whole process of automatically registering, in the messenger service, the partner terminal 100b installing the same messenger program by using a phone number registered in the user terminal 100a. Also, the user may use the messenger service in accordance with a normal membership procedure. In this case, the member managing module 220 may support the whole process of adding information about the partner terminal 100b in the messenger service in various manners such as a normal ID, an email address, etc. rather than a phone number.

Additionally, the member managing module 220 may perform a function of storing and managing, for a certain period of time, various messages and contents transmitted or received by each user.

The chat session processing module 230 may identify users, subscribed in the messenger service, by means of user identifiers, manage a status, a receiving mode, a message recipient list, and subscriber environment information with regard to each subscribed user, and manage an IM chat session, i.e., a chat channel, for delivery of IM chat messages between on-line users. Also, the chat session processing module 230 may perform an SIP (Session Initiation Protocol) call processing and MSRP (Message Session Relay Protocol) relay function or the like, and through this, can allow transmission and reception of messages or contents between a plurality of terminals, e.g., the user terminal 100a and the partner terminal 100b.

The messenger program providing module 240 supports a function of performing various processes in connection with the messenger program. For example, the messenger program providing module 240 may support the whole process of providing the messenger program to a requesting terminal 100 and, if there is update information, support a process of delivering the update information to the terminal 100.

The messenger function supporting module 250 supports the whole process associated with processing of various messenger functions offered by the messenger program. The messenger function supporting module 250 may perform the group icon organizing method according to embodiments of this invention. Namely, even though operations of the group icon organizing method of this invention can be performed by the terminal 100 as discussed with reference to FIG. 2, such operations may be also performed by the messenger service apparatus 200.

In other words, when the messenger program is executed at the terminal 100a, the messenger function supporting module 250 may identify one or more chat window lists pre-created in connection with the terminal 100a and then provide this to the terminal 100a. If there is an item for the group chat window connected with two or more partner terminals 100b in the chat window list, the messenger function supporting module 250 may create the group icon and then provide the group icon to the terminal 100a to display it on a certain area of the group chat window.

Additionally, when the terminal 100a performs the group chat with two or more partner terminals 100b, the messenger function supporting module 250 may identify messages associated with the group chat and then dynamically change the group icon.

The messenger function supporting module 250 may create the group icon by merging, based on a predefined rule, the user icons for the partner terminals 100b participating in the group chat. Namely, each user of the terminals 100 that use the messenger program may set a user icon for distinguishing the user from the other users. Here, information that can be assigned to the user icon may include emoticons, text, images, etc. offered by the messenger service apparatus 200, or any other information that can be set by a user. For example, a user of the terminal 100a may assign a specific photo stored in the terminal 100a to the user icon.

The messenger function supporting module 250 may create the group icon by merging the user icons of two or more partner terminals 100b, except the user icon of the user terminal 100a (if necessary, may be included depending on system implementations), based on a predefined rule. At this time, the messenger function supporting module 250 may create the group icon by arranging and merging the user icons of the partner terminals in the order of participating in the group chat. Also, if there is a predefined keyword in messages transmitted or received to or from the partner terminals 100b through the group chat window, the messenger function supporting module 250 may create the group icon in the group chat window by using the group icon assigned to the predefined keyword. Also, when creating the group icon by merging the user icons for two or more partner terminals 100b, the messenger function supporting module 250 may determine reference colors of two or more user icons and create the group icon according to the determined reference colors.

In addition, if there are user icons of the partner terminals 100b more than the maximum number of mergeable user icons when user icons for two or more partner terminals 100b are merged, the messenger function supporting module 250 may extract specific user icons and then merge the extracted user icons into the group icon.

Hereinbefore, main elements and operations of the messenger service apparatus 200 according embodiments of this invention have been described.

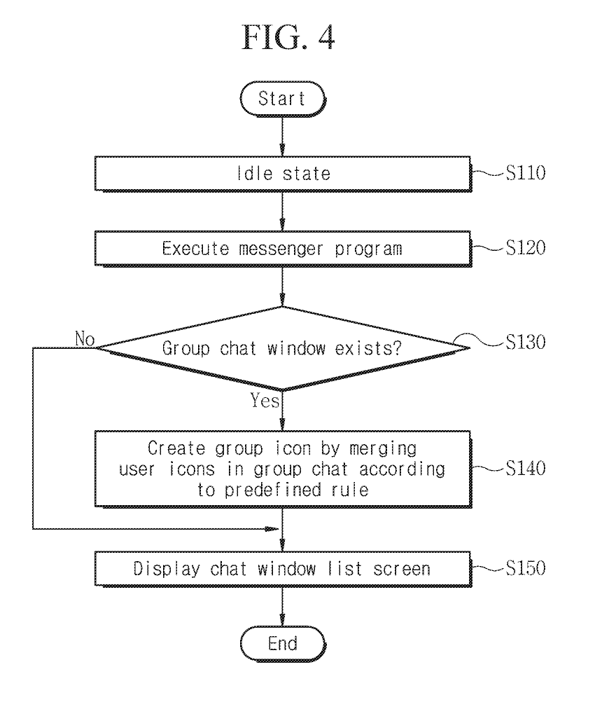

Hereinafter, a method for organizing a group icon in a messenger service according to embodiments of this invention will be described with reference to FIGS. 4 to 8.

Although the following description will suppose that operations of the group icon organizing method in the messenger service according to embodiments of this invention is performed mainly at the terminal 100, this is exemplary only. Alternatively, such operations may be performed at the messenger service apparatus 200, and in this case, the group icon organizing method may be different somewhat in procedure or flow from that of the terminal 100.

FIG. 4 is a flow diagram illustrating a method for organizing a group icon in a messenger service according to one embodiment of the present invention.

Referring to FIGS. 1 and 4, when electric power is supplied, the terminal 100 according to an embodiment of this invention may distribute the power to respective elements thereof and thereby perform an idle state at step S110. Here, the idle state may be a concept of including all previous operations before the terminal 100 executes a messenger program.

The terminal 100 executes the messenger program (S120). Here, the terminal 100 may execute the messenger program in response to a user's request for executing the messenger program.

Then the terminal 100 may display various execution screens of the messenger program. For example, various execution screens such as a buddy list screen, a chat window list screen, and a notice screen that can be found through the messenger program may be displayed. In case the terminal 100 displays the chat window list screen, the terminal 100 checks whether any group chat window exists (S130). If there is a group chat window, the terminal 100 creates a group icon by merging, based on a predefined rule, user icons participating in a group chat (S140), controls the created group icon to be displayed in a certain area of the group chat window, and displays a chat window list screen (S150).

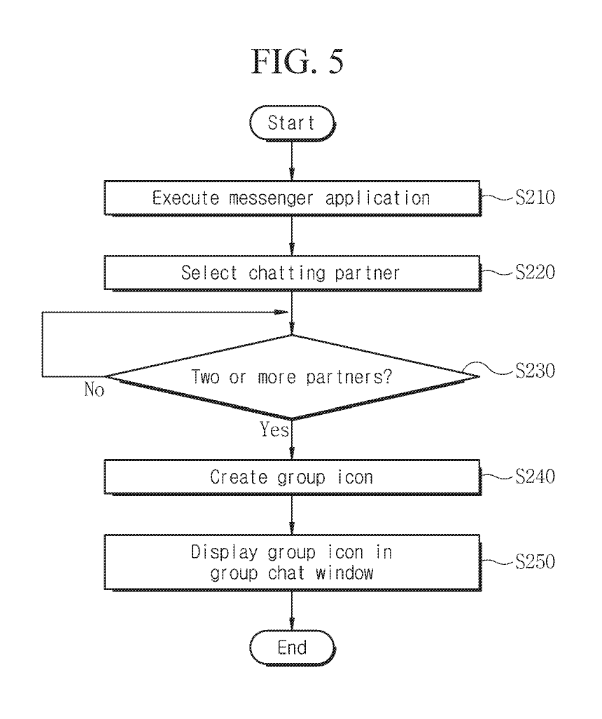

FIG. 5 is a flow diagram illustrating a method for organizing a group icon in a messenger service according to another embodiment of the present invention.

Namely, FIG. 4 shows a process of displaying a group icon in a pre-created chat window list screen, and FIG. 5 shows a process of displaying a group icon in a group chat window screen in which a group chat can be performed by selecting a chatting partner.

Referring to FIGS. 1 and 5, in an idle state as discussed above, the terminal 100 executes a messenger application (S210), and a user may select a chatting partner to perform a group chat (S220). At this time, if it is checked that two or more partners are selected (S230), the terminal 100 creates a group icon (S240) and displays the group icon in a group chat window (S250).

Hereinafter, the group icon organizing method of this invention will be described in detail.

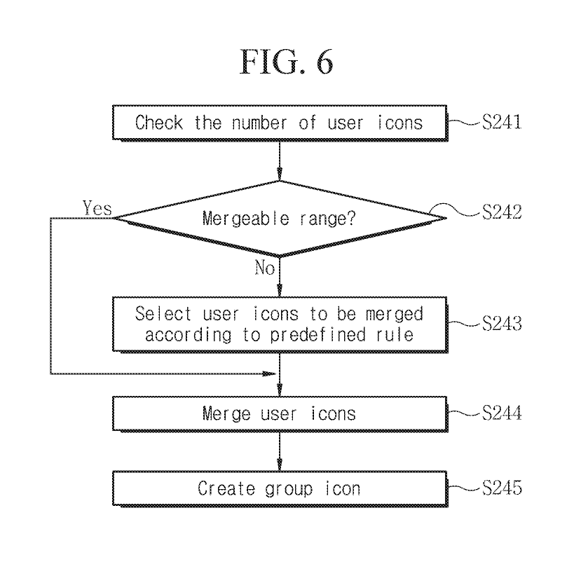

FIG. 6 is a flow diagram illustrating in detail a method for organizing a group icon in a messenger service according to embodiments of the present invention.

Here, respective steps shown in FIG. 6 may be understood as details of step S140 of FIG. 4 or S240 of FIG. 5.

Referring to FIG. 6, before creating a group icon, the terminal 100 identifies the number of user icons (S241).

If the identified number of user icons is within a mergeable range, the terminal 100 may create the group icon by merging the user icons, based on a predefined rule.

However, if the identified number of user icons is not within a mergeable range, the terminal 100 selects user icons to be merged according to a predefined rule (S243). For example, if the maximum number of user icons to be merged to create the group icon is four, and if the number of members who are currently performing a group chat is twenty, the terminal 100 may extract only four user icons.

When extracting the user icon of the partner terminals, the terminal 100 may consider the number of messages transmitted or received through the group chat window or consider the order of entry into the group chat window. Also, a user may directly select the user icons to be merged into the group icon.

After the user icons to be merged are extracted through the above process (S243), the terminal 100 completes the creation by merging the user icons, based on a predefined rule (S244˜S245).

At this time, the terminal 100 may create the group icon by arranging and merging the user icons in the order of participating in the group chat. For example, let's suppose that when the user performs a one-to-one chat with a partner A through a one-to-one chat window, another partner B enters the chat window and thereby the user performs a group chat with partners A and B. In this example, the user terminal 100 may create the group icon by merging the user icons of the partner terminals in the order of partners A and B who participate in the group chat. However, even though having the previous order of participating in the group chat, a partner terminal that does not set the user icon may be excluded from the group icon.

Additionally, if there is a predefined keyword in messages transmitted or received through the group chat window, the terminal 100 may create the group icon in the group chat window by using the group icon assigned to the predefined keyword. For example, if the predefined keyword “love” frequently appears in messages transmitted or received through the group chat window, a heart icon assigned to the keyword “love” may be determined as the group icon. In another example, if the predefined keyword “idol” frequently appears in messages transmitted or received through the group chat window, an entertainer's photo assigned to the keyword “idol” may be determined as the group icon. Further, text such as “talking about ooo” may be displayed near the group icon so as to indicate a current chat topic in the group chat window. In this case, the above steps of identifying the number of user icons and then determining whether the identified number is within a mergeable range may be omitted.

In addition, when creating the group icon by merging user icons, the terminal 100 may determine reference colors of two or more user icons and create the group icon according to the determined reference colors. For example, let's suppose that users of partner terminals participating in the group chat are three users A, B and C. If color information about icons of the users A and B indicates that the leading color is red, and if color information about an icon of the user C indicates that the leading color is blue, the leading color of the user C's icon may be changed to red when the group icon is created by merging icons of the users A, B and C.

As discussed above, the terminal 100 according to embodiments of this invention creates the group icon from various points of view and displays the group icon through the chat window list screen or the group chat window screen. Thus, the user can easily find, through the group icon, information about members currently participating in the group chat or an atmosphere of the group chat.

Also, the group icon may be changed in real time during the group chat.

The above operations of this invention will be described with reference to exemplary screenshots.

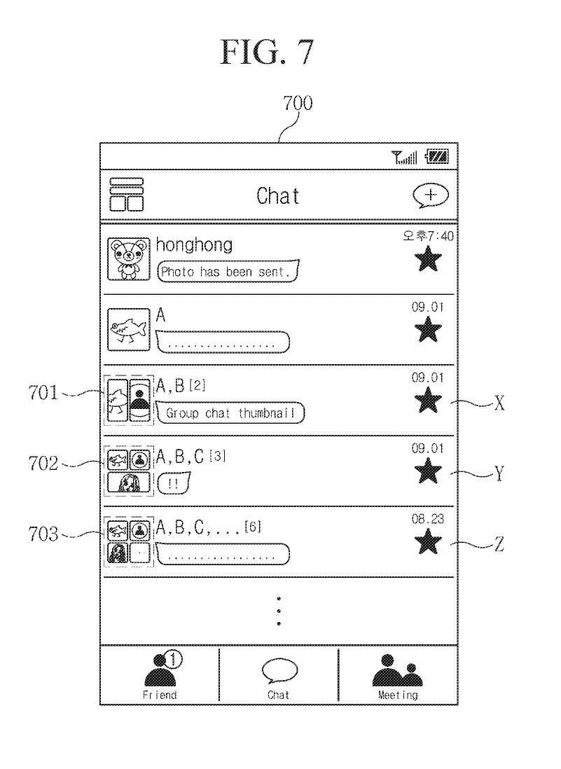

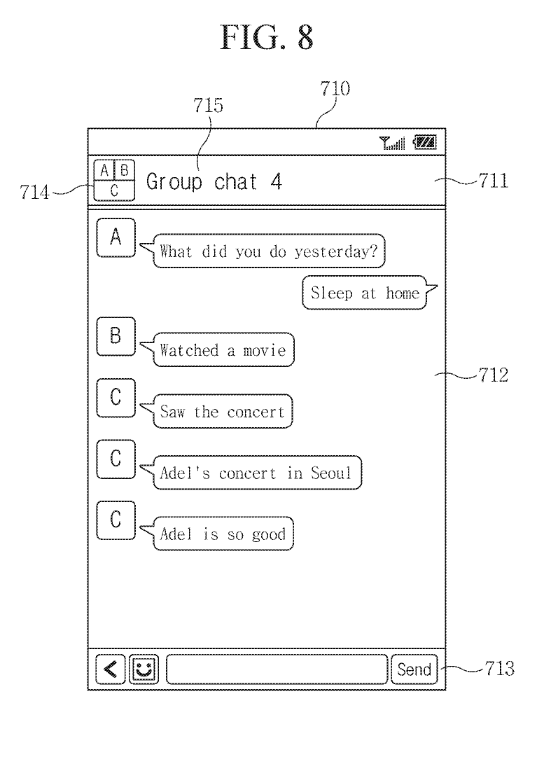

FIGS. 7 and 8 are exemplary screenshots illustrating a group icon organizing method according to embodiments of the present invention.

A screenshot shown in FIG. 7 is a chat window list screen of a messenger program. Here, items of chat windows indicated by X, Y and Z correspond to items of group chat windows. The terminal 100 may display a group icon in a certain area of the item of this group chat window. Namely, group icons 701, 702 and 703 created on the basis of user icons (or messages) are displayed in a certain area of each group chat window.

Here, the number of members in the group chat window may be counted including or excluding the user. In the group chat window “X”, a chat with two partners is in progress, and thus the group icon 701 of the group chat “X” represents user icons of two partners merged in parallel. The group icon 702 represents user icons of three merged partners. In case of the group chat “X”, the number of members participating in a chat is six and exceeds the maximum number of mergeable user icons. In this case, the terminal 100 may extract four user icons based on a predefined rule, merges the extracted four user icons only, and then create the group icon as indicated by 703.

On the other hand, a screenshot shown in FIG. 8 is a group chat window screen 710 of a messenger program.

The group chat window screen 710 of the messenger program may be composed of an upper region 711, a message display region 712, and a lower region 713. From the upper region 711 of the messenger program chat window screen, it is possible to find information about members connected through the messenger program group chat window screen. Here, information about members may include a group icon 714, group information 715, and the like. Although not shown, a menu button for adding other user, a call button for a voice or video call between users, an exit button for leaving the current chat window screen, etc. may be further displayed.

On the message display region 712, messages received from partners and messages entered by the user may be displayed in sequence. At this time, in order to distinguish between transmitted and received messages, messages received from partners may be displayed on the left side of the screen, and messages entered by the user may be displayed on the right side of the screen. This is, however, exemplary only. The time when a message is received or entered may be also displayed together with the message. In addition, the messages may be displayed separately by date.

Additionally, in the lower region 713 of the messenger program chat window screen, a content sharing screen display menu for sharing information, e.g., contents such as photo or music with the partner terminal connected through the chat window screen, a menu for sending emoticon, sticker, etc. to the partner terminal, a message input box, and the like may be contained. Also, in the lower region of the messenger program chat window screen, a send button for sending a message, entered in the input box by the user, to the partner terminal connected through the chat window screen. In this case, the send button may be activated and displayed only when a cursor is placed in the input box, namely, only when the input box is touched. Otherwise, a button for creating a voice message may be displayed.

Additionally, in case of transmitting the entered message to the partner in a predetermined input manner, e.g., a drag toward the message display region, the send button may be omitted.

When the user enters a certain input, e.g., a touch input, into the input box, the terminal 100 may activate a cursor in the input box such that the user is aware that text can be entered via the input box. Also, depending on types of implementing messenger, a text input region may be activated and displayed in the lower region of the messenger program chat window screen, or alternatively the lower region of the messenger program chat window screen may move upward and thus the message display region may be reduced somewhat by the area where the text input region is displayed.

Although not shown, the terminal 100 may inactivate the text input region not to be displayed when a user's input is detected from a return button (which may be inserted in the messenger program and displayed, or used as an inherent button of the terminal 100) on the above-discussed screen. If a further input is detected from the return button, the terminal 100 may leave the current chat window screen and then display a certain execution screen of the messenger program.

In a process of transmitting and receiving messages through the group chat window screen, the terminal 100 may dynamically change the group icon depending on such messages. For example, if it is determined that a user C is leading a chat as a result of the number of messages currently transmitted and received, the terminal 100 may adjust a merging ratio such that the user C's icon may occupy a larger area in the group icon created by merging user icons. This process may be performed in real time during the chat. Also, the terminal 100 may find the recent chat topic, e.g., “Adel's concert”, from the content of messages sent and received, and assign a specific icon (e.g., photo) corresponding to “Adel's concert” to the group icon. This group icon based on the content of messages may be displayed, together with the group icon, as the topic of the group chat in the form of text such as “chatting about Adel's concert”.

Hereinbefore, the method for organizing the group icon in the messenger service according to embodiments of this invention has been described.

The above-discussed method for organizing the group icon in the messenger service according to embodiments of this invention may be provided in the form of a computer-readable storage medium suitable for recording thereon computer program commands and data. A program recorded on a computer-readable storage medium for executing the method for organizing the group icon in the messenger service according to an embodiment of this invention may execute step of, when a messenger program is executed, determining whether there is a group chat window connected with at least two partner terminals in one or more pre-created chat windows, step of, if there is the group chat window, creating a group icon, based on a predefined rule, by merging user icons for partner terminals participating in a corresponding group chat, and step of controlling an item for the group chat window containing the created group icon to be displayed through one or more pre-created chat window lists.

This program recorded on the storage medium may perform the above-discussed functions by being installed, read and executed in and by a computer.

These programs may include codes in programming languages such as C, C++,

JAVA and machine codes readable by a computer processor or CPU so that the computer reads the programs recorded in recording media to conduct the foregoing functionalities.

The codes may include functional codes related to functions defining the aforementioned functionalities and control codes related to an execution procedure needed for the computer processor to execute the functionalities according to a preset procedure. Further, the codes may further include memory reference related codes regarding additional information needed for the computer processor to perform the functionalities or a location or address of an internal or external memory that media refer to. In addition, when the computer processor needs communications with a remote computer or server to perform the functionalities, the codes may further include communication related codes regarding how the computer processor communicates with which remote computer or server using a wire-based and/or wireless communication module and what kind of information or media the computer processor transmits or receives in communications.

The computer-readable storage medium suitable for storing computer program commands and data may include magnetic media such as a hard disk, a floppy disk and a magnetic tape, optical media such as CD-ROM (Compact Disk Read Only Memory) and DVD (Digital Video Disk), magneto-optical media such as a floptical disk, and semiconductor memories such as ROM (Read Only Memory), RAM (Random Access Memory), flash memory, EPROM (Erasable Programmable ROM) and EEPROM (Electrically EPROM). A processor and memory may be supplemented by a special-purpose logic circuit or integrated therewith.

Further, the computer-readable recording media including the programs may be distributed to a computer system connected via a network, and accordingly computer-readable codes may be stored and implemented in distributed mode. Functional programs, relevant codes and code segments to implement the present invention may be readily inferred or modified by programmer skilled in the art in view of a system configuration of the computer that reads the recording media to execute the programs.

Respective steps in embodiments of this invention may be implemented in computer-executable commands and executed by a computing system. This computing system is defined as one or more software modules, one or more hardware module, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network.

Likewise, a computer system may include a single physical device where internal modules, such as a memory and processor, work together to perform operations on electronic data.

Namely, a device for performing the location estimating method according to this invention may be implemented to perform the above-discussed embodiments based on a computing system to be described hereinafter.

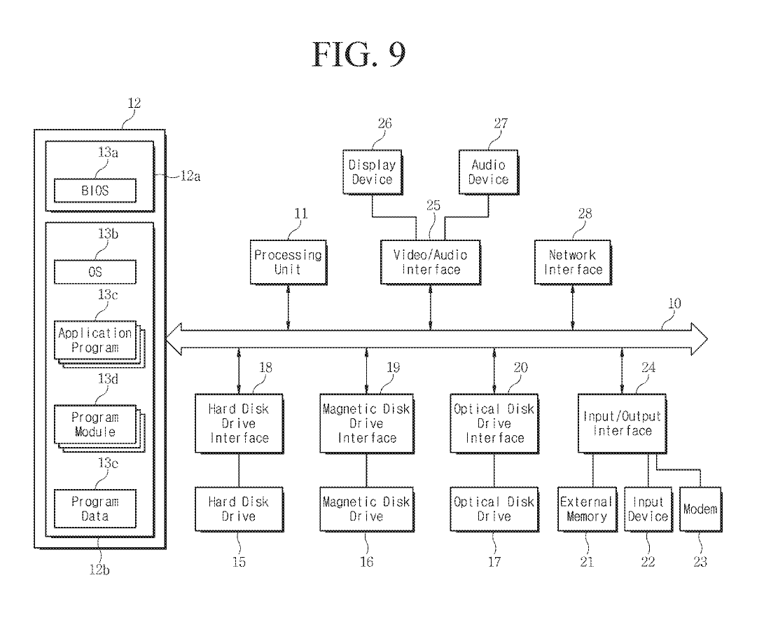

FIG. 9 is a block diagram illustrating an operating environment of an apparatus for organizing a group icon according to embodiments of the present invention.

FIG. 9 and the following discussion are intended to provide a brief, general description of an example suitable computing environment in which the invention may be implemented. Although not required (e.g., when implemented in hardware), the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

Referring to FIG. 9, an exemplary computing system for implementing the invention includes a processing unit 11, a system memory 12, and a system bus 10 that couples various system components including the system memory 12 to the processing unit 11.

The processing unit 11 can execute computer-executable instructions designed to implement features of this invention.

The system bus 10 may be any of several, types of bus structures including a memory bus or memory controller, a peripheral bus, and a local bus using any of a variety of bus architectures. The system memory 12 includes read only memory (ROM) 12a and random access memory (RAM) 12b. A basic input/output system (BIOS) 13a, containing the basic routines that help transfer information between elements within computer system, such as during start-up, may be stored in the ROM 12a.

The computing system may also include a storage unit, e.g., a hard disk drive 15 for reading from and writing to a hard disk, a magnetic disk drive 16 for reading from or writing to a magnetic disk, and an optical disk drive 17 for reading from or writing to an optical disk such as a CD-ROM or other optical media. The hard disk drive 15, the magnetic disk drive 16, and the optical disk drive 17 are connected to the system bus 10 by a hard disk drive interface 18, a magnetic disk drive-interface 19, and an optical drive interface 20, respectively.

Additionally, the computing system may further include an external memory 21 as the storage unit. The external memory 21 may be connected to the system bus 10 through an input/output interface 24.

The drives and their associated computer-readable media provide nonvolatile storage of computer-executable instructions, data structures, program modules, and other data for the computing system. Although the example environment described herein employs the hard disk 15, the magnetic disk 16 and the optical disk 17, other types of computer readable media for storing data can be used, including magnetic cassettes, flash memory cards, digital versatile disks, Bernoulli cartridges, RAMs, ROMs, and the like.

Program code means including one or more program modules, such as an operating system 13b, one or more application programs 13c, other program modules 13d, and program data 13e, may be stored on the hard disk 15, the magnetic disk 16, the optical disk 17, the ROM 12a, or the RAM 12b.

A user may enter commands and information into the computing system through other input device 22 such as a keyboard, a pointing device, a microphone, a joy stick, a game pad, or the like. This other input device 22 can be connected to the processing unit 11 through the input/output interface 24 coupled to the system bus 10. The input/output interface 24 may logically represent any of a wide variety of different interfaces, such as, for example, a serial port interface, a PS/2 interface, a parallel port interface, a universal serial bus (USB) interface, or an institute of electrical and electronics engineers (IEEE) 1394 interface (i.e., a FireWire interface), or may even logically represent a combination of different interfaces.

Additionally, the computing system may further include a display device 26 such as a monitor or LCD and/or an audio device 27 such as a speaker or a microphone, which are connected to the system bus 10 via a video/audio interface 25. The video/audio interface 25 may include high definition multimedia interface (HDMI), graphics device interface (GDI), or the like.

The computing system is connectable to networks, such as, for example, an office-wide or enterprise-wide computer network, a home network, an intranet, and/or the Internet. The computing system can exchange data with external sources, such as, for example, remote computer systems, remote applications, and/or remote databases over such networks.

The computing system includes a network interface 28, through which the computing system receives data from external sources and/or transmits data to external sources.

The network interface 28 facilitates the exchange of data with remote devices. For example, if the computing system is the terminal 100, this may transmit or receive information to or from the messenger service apparatus 200 through the network interface 28. If the computing system is the messenger service apparatus 200, this may transmit or receive information to or from the terminal 100 through the network interface 28. The network interface 28 can logically represent one or more software and/or hardware modules, such as, for example, a network interface card and corresponding network driver interface specification (NDIS) stack.

Likewise, the computing system receives and/or transmits data from and/or to external sources through the input/output interface 24. The input/output interface 24 is coupled to a modem 23 (e.g., a standard modem, a cable modem, or a digital subscriber line (DSL) modem), through which the computing system receives data from and/or transmits data to external sources.

While FIG. 9 represents a suitable operating environment for the present invention, the principles of the present invention may be employed in any system that is capable of, with suitable modification if necessary, implementing the principles of the present invention. The environment illustrated in FIG. 9 is illustrative only and by no means represents even a small portion of the wide variety of environments in which the principles of the present invention may be implemented.

The messenger program of this invention and various kinds of information generated during the execution of the messenger program may be stored and accessed from any of the computer-readable media associated with the computing system as shown in FIG. 9. For example, portions of such modules and portions of associated program data may be included in the operating system 13b, the application programs 13c, the program modules 13d and/or the program data 13e, for storage in the system memory 12.

When a mass storage device such as the hard disk is coupled to the computing system, such modules and associated program data may also be stored in the mass storage device. In a networked environment, program modules depicted relative to the computing system, or portions thereof, can be stored in a remote computer system connected through the modem 23 or network interface 25 of the input/output interface 24. Execution of such modules may be performed in a distributed environment as previously described.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

Certain embodiments of the subject matter have been described. Other embodiments are within the scope of the following claims. For example, the operations recited in the claims may still be performed in a different order and still achieve desirable results. By way of example, the process illustrated in the accompanying drawings does not necessarily require that particular illustrated or sequential order to obtain the desired results. In certain implementations, multitasking and parallel processing may be advantageous.

While this disclosure has been particularly shown and described with reference to an exemplary embodiment thereof, it will be understood by those skilled in the art that various changes in form and details may be made therein without departing from the scope of this disclosure as defined by the appended claims.

Therefore, the scope of the present invention should not be limited by the described embodiments but should be defined by the claims.

### INDUSTRIAL APPLICABILITY

The present invention relates to a method for organizing a group icon in a messenger service and, more particularly, to a group icon organizing method and apparatus for merging information about members of a group chat in a messenger service and displaying the merged information through a group icon so as to simply provide such information about group chat members.

According to this invention, it is possible to easily find information about members participating in a group chat through the group icon during the group chat in the messenger service. Therefore, this invention can contribute to the development of the messenger service industry.

Further, the present invention has a good possibility of sales on the market or business and also has industrial applicability suitable for practical and apparent implementation.

1] An apparatus for organizing a group icon in a messenger service, the apparatus comprising:
a message display module configured to display information associated with an execution of a messenger program;
a messenger processing module configured to display, through the message display module, a chat window list screen of the messenger program on which one or more pre-created chat window lists are displayed, and to, if there is an item for a group chat window connected with at least two partner terminals in the chat window list, control the group icon, requested and delivered from a group icon creation module, to be displayed on an item for the group chat window; and
the group icon creation module configured to create, based on a predefined rule, the group icon by merging user icons for partner terminals participating in a group chat.

2] The apparatus of claim 1, wherein the messenger processing module is further configured to display a group chat window screen selected from the chat window list screen, and to, if the group icon changed according to messages transmitted or received through the group chat window is delivered through the group icon creation module, control the changed group icon to be displayed in a certain area of the group chat window screen.

3] The apparatus of claim 1, wherein the group icon creation module is further configured to create the group icon by arranging and merging user icons of the at least two partner terminals in the order of participating in the group chat.

4] The apparatus of claim 1, wherein the group icon creation module is further configured to, if there is a predefined keyword in messages transmitted or received to or from the at least two partner terminals through the group chat window, create the group icon by using an icon assigned to the predefined keyword.

5] The apparatus of claim 1, wherein the group icon creation module is further configured to, when creating the group icon by merging the user icons, determine reference colors of the user icons and create the group icon according to the determined reference colors.

6] The apparatus of claim 1, wherein the group icon creation module is further configured to, if there are user icons of the partner terminals more than the maximum number of user icons being mergeable into the group icon, extract specific user icons and merge the extracted user icons into the group icon.

7] The apparatus of claim 6, wherein the group icon creation module is further configured to, when extracting the specific user icons, consider the number of messages transmitted or received through the group chat window or consider the order of entry into the group chat window.

8] A method for organizing a group icon in a messenger service, the method comprising steps of:
when a messenger program is executed, determining whether there is a group chat window connected with at least two partner terminals in one or more pre-created chat windows;
if there is the group chat window, creating a group icon, based on a predefined rule, by merging user icons for partner terminals participating in a corresponding group chat; and
controlling an item for the group chat window containing the created group icon to be displayed through one or more pre-created chat window lists.

9] The method of claim 8, further comprising steps of:
when one group chat window is selected from the chat window list screen, displaying the selected group chat window screen;
changing the group icon according to messages transmitted or received through the group chat window; and
controlling the changed group icon to be displayed in a certain area of the group chat window screen.

10] A computer-readable storage medium recording thereon a program for executing a for organizing a group icon in a messenger service, the method comprising steps of:
when a messenger program is executed, determining whether there is a group chat window connected with at least two partner terminals in one or more pre-created chat windows;
if there is the group chat window, creating a group icon, based on a predefined rule, by merging user icons for partner terminals participating in a corresponding group chat; and
controlling an item for the group chat window containing the created group icon to be displayed through one or more pre-created chat window lists.
